(19) United States
(12) Patent Application Publication
(10) Pub. No.: US 2023/0337185 A1
(43) Pub. Date: Oct. 19, 2023

(54) WAKE-UP SIGNALS IN CELLULAR SYSTEMS

(71) Applicant: Huizhou TCL Cloud Internet Corporation Technology Co., Ltd., Huizhou, Guangdong (CN)

(72) Inventors: Sebastian Wagner, Huizhou, Guangdong (CN); Nanterre France, Huizhou, Guangdong (CN)

(73) Assignee: Huizhou TCL Cloud Internet Corporation Technology Co., Ltd., Huizhou, Guangdong (CN)

(21) Appl. No.: 18/026,836

(22) PCT Filed: Sep. 23, 2021
(86) PCT No.: PCT/CN2021/119917

§ 371 Date: Mar. 17, 2023

Related U.S. Application Data
(60) Provisional application No. 63/085,575, filed on Sep. 30, 2020.

(51) Int. Cl. H04W 68/02

(52) U.S. Cl. CPC H04W 68/025

(57) ABSTRACT

A sequence of paging indication messages is transmitted, whereby each message indicates which UEs should decode subsequent signals. Each paging indication message may refer to a further paging indication message or to a paging message. The paging indication messages may be reference signal based or DCI based.

### TECHNICAL FIELD

The following disclosure relates to the transmission of wake-up signals in cellular networks, and in particular wake-up signal configurations to avoid false paging.

### BACKGROUND

Wireless communication systems, such as the third-generation (3G) of mobile telephone standards and technology are well known. Such 3G standards and technology have been developed by the Third Generation Partnership Project (3GPP)®. The 3rd generation of wireless communications has generally been developed to support macro-cell mobile phone communications. Communication systems and networks have developed towards a broadband and mobile system.

In cellular wireless communication systems User Equipment (UE) is connected by a wireless link to a Radio Access Network (RAN). The RAN comprises a set of base stations which provide wireless links to the UEs located in cells covered by the base station, and an interface to a Core Network (CN) which provides overall network control. As will be appreciated the RAN and CN each conduct respective functions in relation to the overall network. For convenience the term cellular network will be used to refer to the combined RAN & CN, and it will be understood that the term is used to refer to the respective system for performing the disclosed function.

The 3rd Generation Partnership Project has developed the so-called Long Term Evolution (LIE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB. NR is proposed to utilise an Orthogonal Frequency Division Multiplexed (OFDM) physical transmission format.

The NR protocols are intended to offer options for operating in unlicensed radio bands, to be known as NR-U. When operating in an unlicensed radio band the gNB and UE must compete with other devices for physical medium/resource access. For example, Wi-Fi®, NR-U, and LAA may utilise the same physical resources.

A trend in wireless communications is towards the provision of lower latency and higher reliability services. For example, NR is intended to support Ultra-reliable and low-latency communications (URLLC) and massive Machine-Type Communications (mMTC) are intended to provide low latency and high reliability for small packet sizes (typically 32 bytes). A user-plane latency of 1 ms has been proposed with a reliability of 99.99999%, and at the physical layer a packet loss rate of 10⁻⁵ or 10⁶ has been proposed.

mMTC services are intended to support a large number of devices over a long life-time with highly energy efficient communication channels, where transmission of data to and from each device occurs sporadically and infrequently. For example, a cell may be expected to support many thousands of devices.

The disclosure below relates to various improvements to cellular wireless communications systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

There is provided a method of paging UEs in a cellular communications system, the method performed at a base station and comprising the steps of transmitting a first paging indication, wherein the first paging indication includes an indication of UEs which should decode a second paging indication; transmitting the second paging indication, wherein the second paging indication includes an indication of which of the UEs can expect a paging message in a subsequent paging occasion; and transmitting a paging message in the subsequent paging occasion for reception by the UEs indicated in the second paging indication.

There is also provided a method of paging UEs in a cellular communications network, the method performed at a UE and comprising the steps of receiving a first paging indication; determining whether the first paging indication includes an indication that the UE should decode a second paging indication and if so indicated receiving the second paging indication; and determining whether the second paging indication includes an indication that the UE should decode a paging message, and if so indicated receiving and decoding the paging message.

The second paging indication may be transmitted subsequent to the first paging indication.

The method may further comprise transmitting at least one synchronisation signal block between the first paging indication and the paging message.

The first paging indication may be reference-signal based.

The first paging indication may be a DCI message.

The second paging indication may be reference-signal based.

The second paging indication may be a DCI message.

The first paging indication may indicate a group of UEs or all UEs, associated with the paging occasion.

The first paging indication may include at least one sequence corresponding to a predefined group of UEs.

The second paging indication may include at least one sequence corresponding to a predefined group of UEs.

The DCI message of the first paging indication may identify at least one group of UEs.

The DCI message of the first paging indication may include a bitmap, wherein each bit of the bitmap corresponds to a predefined group of UEs.

The paging message may be a paging DCI message.

The paging DCI message may be a common DCI message.

The paging DCI message may be a group-common DCI message.

The paging DCI message may be scrambled by the relevant P-RNTI.

The paging message may comprise a plurality of paging DCI messages, each associated with a different CORESET and/or scrambled by a different P-RNTI

The CORESET and/or P-RNTI of a paging DCI message for a UE may be indicated by the second paging indication.

There is also provided a method of paging UEs in a cellular communications system, the method performed at a base station and comprising the steps of transmitting a first paging indication, wherein the first paging indication is a paging indication DCI message scrambled with a paging indication RNTI, wherein the paging indication DCI message includes an indication of at least one group of UEs which should decode a subsequent paging DCI message; and transmitting the paging DCI message, wherein the paging DCI message includes an indication of which of the UEs indicated by the paging indication DCI message the paging DCI message is intended for.

There is also provided a method of paging UEs in a cellular communications system, the method performed at a UE and comprising the steps of receiving a first paging indication, wherein the first paging indication is a paging indication DCI message scrambled with a paging indication RNTI, wherein the paging indication DCI message includes an indication of at least one group of UEs which should decode a subsequent paging DCI message; and if the paging indication DCI message indicates the UE should decode the subsequent paging DCI message, decoding that subsequent paging DCI message.

The at least one group of UEs may be indicated utilising a bitmap.

The paging indication DCI message may be transmitted in a CORESET, and/or scrambled by a PI-RNTI corresponding to the UEs to which the paging indication DCI message is directed.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding

FIG. 1 shows selected elements of a cellular communications system; and

FIGS. 2 to 9 show examples of paging sequences.

### DETAILED DESCRIPTION OF THE PREFERRED EMBODIMENTS

Those skilled in the art will recognise and appreciate that the specifics of the examples described are merely illustrative of some embodiments and that the teachings set forth herein are applicable in a variety of alternative settings.

FIG. 1 shows a schematic diagram of three base stations (for example, eNB or gNBs depending on the particular cellular standard and terminology) forming a cellular network. Typically, each of the base stations will be deployed by one cellular network operator to provide geographic coverage for UEs in the area. The base stations form a Radio Area Network (RAN). Each base station provides wireless coverage for UEs in its area or cell. The base stations are interconnected via the X2 interface and are connected to the core network via the S1 interface. As will be appreciated only basic details are shown for the purposes of exemplifying the key features of a cellular network. A PC5 interface is provided between UEs for SideLink (SL) communications. The interface and component names mentioned in relation to FIG. 1 are used for example only and different systems, operating to the same principles, may use different nomenclature.

The base stations each comprise hardware and software to implement the RAN's functionality, including communications with the core network and other base stations, carriage of control and data signals between the core network and UEs, and maintaining wireless communications with UEs associated with each base station. The core network comprises hardware and software to implement the network functionality, such as overall network management and control, and routing of calls and data.

For certain categories of device operating in cellular networks power consumption is a critical parameter. 3GPP have specified a Machine-Type Communication (MTC) UE type in LTE for the implementation of devices like industrial sensors expected to function for several years on a single battery charge. For static and nomadic devices (IoT) the NB-IoT standard may be utilised.

To reduce power consumption such devices may spend significant portions of time in RRC IDLE/INACTIVE mode utilising discontinuous reception (DRX) to turn off their radio systems, only waking to listen for paging messages. Although paging occasions for the possible reception of paging messages are infrequent, the process of decoding a paging message is complex and consumes a relatively significant amount of power. For example, a UE must wake up prior to the expected Paging Occasion (PO), turn on RF and baseband systems, synchronise in time and frequency, and attempt to decode PDCCH for a paging DCI scrambled with P-RNTI. If no paging DCI is detected the UE can return to sleep (DRX). The process can take several frames, depending PDCCH repetition, and PDCCH decoding is relatively complex. In order to reduce this complexity a Wake-Up Signal (WUS) may be transmitted for detection by UEs prior to a paging occasion in which a paging message is to be transmitted to a UE. The WUS is typically sequence-based to enable easy detection without requiring decoding and baseband processing. UEs are configured to wake-up to detect the WUS, and if the UE's signal is detected the UE wakes up fully to receive the PDCCH at the appropriate time as it has confidence there is a paging message. If the WUS is not detected the UE can return to sleep. The reduced complexity of detecting the WUS (which may be performed using a correlator) reduces power consumption compared to performing a full PDCCH decode.

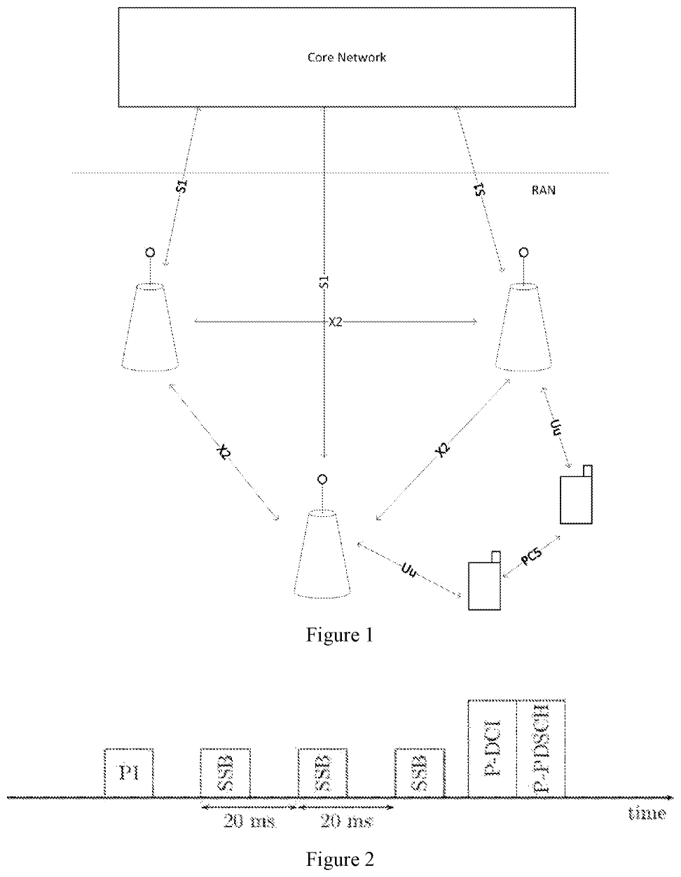

FIG. 2 shows timeline of signals for paging a UE. A Paging Indication (PI) may be transmitted prior to the Paging Occasion (PO) (P-DCI/P-PDSCH) to indicate that a group of UEs, or all UEs associated with the PO, are to be paged. If a UE does not detect a relevant PI it can return to sleep without proceeding further. After the PI one or more SSBs may be detected for the UE to confirm the cell and for time/frequency synchronisation to assist with PDCCH detection and decoding. P-DCI and P-PDSCH scrambled with P-RNTI may then be received by UEs being paged.

The PI may be a DCI-based or a Reference Signal (RS) based design. A DCI-based signal has higher payload capacity and may require fewer specification amendments but requires coherent detection and hence incurs higher power consumption. RS-based systems require only non-coherent detection and hence may have lower UE power consumption and are also more robust to time/frequency offsets. The RS signal itself can also be used for time/frequency synchronisation. However, they have lower capacity.

The higher capacity of the DCI-based system may be utilised for UE grouping, and may also include a short paging message in the DCI. However, detection complexity and power consumption are higher. UE-grouping information can also be included in the P-DCI to indicate which groups of UEs should proceed to decode P-DCI and P-PD SCH.

Disclosed below are various methods intended to reduce the false paging rate by utilising sub-grouping of UEs sharing a PO with improved signalling configurations.

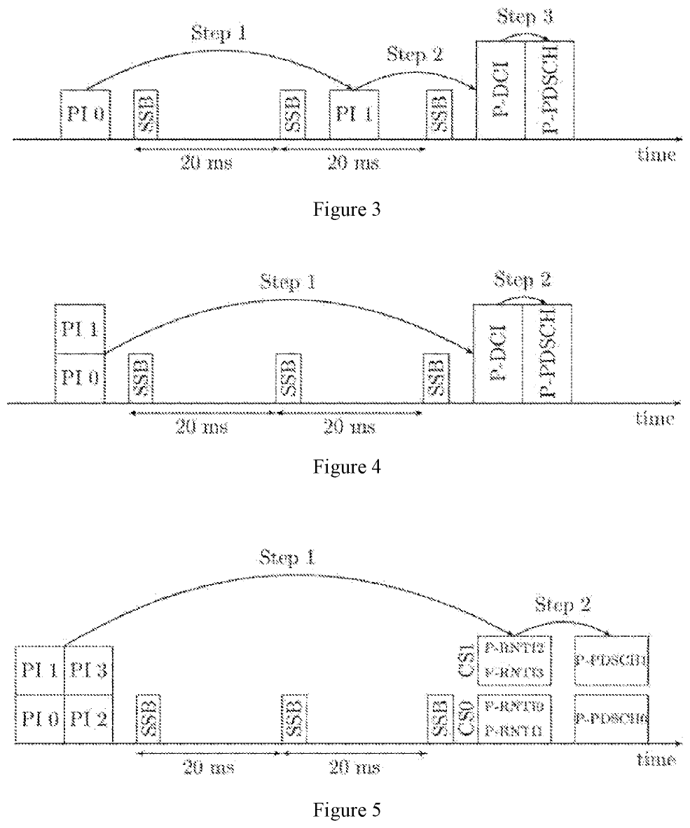

FIG. 3 shows a timeline of a paging method showing the general principles of the following disclosure. The paging method utilises a series of steps to refine the UEs addressed at each stage. In a first step a first PI (PI 0) is transmitted which indicates UE group(s) that are to be paged and which should decode the next PI(s) (PI 1). PI 1 is then transmitted in step 2 which refines the UE groups to those which need to decode the P-DCI. At step 3 the P-DCI indicates the UEs which should proceed to decode the P-PDSCH(s). This sequential arrangement allows the UEs which incur the full power consumption of decoding the P-PDSCH to be reduced, while also managing signalling overhead.

In the example of FIG. 3, two stages of PI are utilised, but this may be extended to any number of PI(s) as required by the relevant number of UE groups and system characteristics. Each PI may be RS- or DCI-based. In an example the first PI (PI 0) may be RS-based for detection by low-power UEs (e.g. REDCAP UEs), while the second PI (PI 1) may be DCI-based to convey further details refining which UEs or groups should proceed to decode P-DCI. PI 0 and the intervening SSB can be used by UEs to synchronise and improve detection of PI 1. As set out below, different combinations of RS & DCI signals, and the included data, may be utilised in paging processes.

In summary, there is described a paging method in which more than one Paging Indication (PI) is transmitted sequentially prior to the Paging Occasion (PO). Each PI may be RS or DCI based and may include an indication of UEs which should proceed to decode the next signal in the process.

UE grouping information included in the PIs may utilise any appropriate format. Specific examples are described hereinbelow which may be particularly appropriate for the subsequently described methods. In the following description it is assumed a DCI has B bits for grouping information and a total of G groups of UEs have been configured. Each UE is assumed to know B and G.

The RS of an RS-based PI may be used to indicate the group of UEs to which the PI relates. A specific sequence may be assigned to each group of UEs with the relevant sequence being transmitted to indicate that at least one UE in the group is to be paged. A reference sequence may also be assigned as a common sequence which is transmitted when UEs in more than one group are to be paged. If permitted, transmission of more than one sequence can be utilised to indicate UEs in more than one group are to be paged rather than utilising the common sequence. However, if more than one sequence is transmitted on the same transmission resource, they have to share power and hence each sequence is transmitted with less power, which may be suboptimal.

If B>=G each bit in the relevant field of the DCI is associated with a UE group. Setting a bit to 1 indicates the group is to be paged and a 0 indicates the group is not being paged (or vice versa). A disadvantage is that the number of bits required is proportional to the number of groups and accordingly the payload can become large to support a large number of groups.

To reduce the number of bits required, each bit may be associated with more than one group. For G groups each of the B bits may be mapped to [GM] groups, G>=B. If G<B only the first G bits can be used to indicate G groups. For example, if G=8 and B=4, each bit represents 2 groups.

In summary, the relevant field of the DCI may be arranged as a bitmap with each bit being associated with one or more groups of UEs.

In an alternative approach the paged groups may be encoded as a sorted list. For example, if G=8 and groups 2, 6, 3, 1 are to be paged the sequence g={1, 2, 3, 6} is encoded into a unique integer r which is transmitted in the DCI payload. If K groups gₖ, k=0, 1, . . . , K−1, out of a maximum of G are to be indicated, the unique integer

$$r ∈ ( 0 , 1 , … . , ( \begin{matrix}G \\ K\end{matrix} ) - 1 )$$

is computed as

$$r = {\sum }_{i = 0}^{K - 1} 〈 \begin{matrix}G - {g}_{i} \\ K - i\end{matrix} 〉$$

where

$$〈 \begin{matrix}x \\ y\end{matrix} 〉 = ( \begin{matrix}x \\ y\end{matrix} )$$

if x>=y and 0 otherwise. If G=8, if only K=1 group is paged, 3 bits are needed. If K=4, then 7 bits are needed. The number of bits required is reduced, but the number of groups K needs to be known in advance.

If the paged groups can not be refined further in the P-DCI, for example if only a single group was indicated to decode the DCI, then the field of the DCI can be used to indicate specific UEs within the group which should decode the PDSCH. For example, UEs to be paged may be indicated using B bits with (UE-ID mod 2^{B}−1)=(0, 1, . . . , 2^{B}−2}. Table 2 shows an example for B=2:

| Bit-field | UE-ID mod 3 |
|---|---|
| 00 | 0 |
| 01 | 1 |
| 10 | 2 |
| 11 | all |

In this example, if the field of the DCI indicates 00 only UEs with (UE-ID mod 3)=0 are to be paged.

FIG. 4 shows an example in which only one occasion of a PI is transmitted, but two resources are provided such that two PIs (PI 0 and PI 1) can be transmitted at that occasion. The two resources are orthogonal such that they do not interfere. Each of the PIs can be used to indicate a specific group, or a common signal indicating all UEs associated with the relevant PI.

In an example, each PI may have 8 possible sequences, each indicating a group, plus a sequence indicating all groups (a “common signal”). PI 0 may indicate group 3 and PI 1 needs to indicate more than one group so the common signal is transmitted. Group 3 associated with PI 0 thus decodes the P-DCI, and all 8 groups associated with PI 1 decode the P-DCI. As discussed above, the P-DCI may further refine the groups of UEs which should decode the P-PDSCH.

One P-DCI may be common for groups associated with both PI 0 and PI 1 or different P-DCIs may be mapped to the PIs, as discussed in more detail below. Different P-DCIs may be associated with different search spaces/CORESETs, and/or different P-RNTIs may be used to scramble each P-DCI (with each P-DCI being transmitted in the same search space/CORESET). In a further example, similar to FIG. 4, the PIs may be DCI-based PIs, each scrambled with different PI-RNTIs and/or transmitted on different Search spaces/CORESETs. An advantage of such a mapping is that all concerned UE groups know how many groups are indicated. Continuing the earlier example, UE group 3 on PI 0 will decode a P-DCI 0 and hence P-DCI 0 can indicate a further refinement of UE group 3. Similarly, for PI 1 UE groups 0 to 7 will decode P-DCI 1 which indicates further which UEs or groups of UEs need to proceed and decode the PDSCH. If a common P-DCI for both PIs is used then UE group 3 on PI 0 will not be aware of the signals transmitted on PI 1, since every UE only monitors the PI it belongs to. Hence, a subsequent group refinement on P-DCI is less efficient.

In the following discussion it is assumed that N bits are available for grouping information in the P-DCI(s) and M PIs are configured in the system. Both N & M are known to the relevant UEs.

If more than one PI is mapped to a subsequent common DCI (either a P-DCI or a subsequent DCI-based PI (PI-DCI)) UEs associated with one PI will have no knowledge about indications transmitted to UEs associated with the other PIs associated with the common DCI. Therefore, a fixed mapping may be used between PIs the DCI payload bits. For example, B=[N/M] bits may be associated to each PI in the DCI payload. If M=2 and N=8, 4 bits are used for each of PI 0 and PI 1, with each bit representing two groups. The bits may have different meanings whether they relate to a group-specific PI or a common PI (refining the UEs or groups respectively).

For example, if groups 2 and 7 associated with PI 1 are to be paged a common signal will be transmitted as PI 1 such that all 8 groups associated with PI 1 will decode the P-DCI. The 4 bits of the P-DCI can then indicate the pairs of groups (since each bit represents two group) which should decode PDSCH and would be set to 01 01 (in which the “ones” indicate groups 2 & 3, and 6 & 7 respectively). The PDSCH then indicates the exact UE-IDs of the paged UEs.

Where a group-specific PI was transmitted the groups cannot be refined further (since only a single group is indicated to decode the P-DCI) and so the relevant field of the P-DCI may be used to indicate which UEs of the relevant group should decode PDSCH, using any of the techniques discussed above. Furthermore, if more bits are available multiple subsets of the bits may be used to indicate partial UE-IDs using a UE-ID mod X function. For instance, if 4 bits are available, two times UE-ID mod 3 can be indicated using 2 bits for each. For example, if the group-specific PI indicated a group containing 9 UEs with UE-IDs 0, 1, 2, 3, 12, 14, 16, 18, 20, one pair of the bits can indicate UE-ID mod 3=1 which would indicate UE-IDs 1 and 16, and the other pair of the bits can indicate UE-ID mod 3=2 which would indicate UE-IDs 2, 14, and 20. 5 UEs out of the group of 9 are thus signalled to decode PDSCH, thereby reducing the number of falsely-paged UEs by nearly 50%. The values shown here are for example only, and different values of X in UE-ID mod X can be utilised, and different number of bits or number of values (i.e. more than the 2 values in this example).

This allows to indicate, e.g. both (UE-ID mod 3)=0 and (UE-ID mod 3)=2.

As discussed above each PI resource may be associated with a specific P-DCI by a specific CORESET and/or P-RNTI. FIG. 5 shows an example in which four PIs are each associated to a unique combination of CORESET and P-RNTI. PI 0 and PI 1 correspond to CORESET 0 which carries two P-DCIs scrambled with P-RNTI 0 and P-RNTI 1. Similarly, PI 2 and PI 3 correspond to CORESET 1 which carries two P-DCIs scrambled with P-RNTI 2 and P-RN TI 3. Although distinct P-RNTIs have been utilised in this example for each P-DCI, the same P-RNTI can be re-used in each CORESET (since the transmission resources do not overlap).

Increasing the number of P-DCIs increases the number of bits available to refine the groups or UEs which should decode the next stage of the paging process (using the options described above), and also enables the paging message to be group-specific. That is, UE groups paged in PI 0 and PI 1 can receive different paging messages. The P-PDSCH corresponding to each P-DCI is scrambled using the same P-RNTI as the corresponding P-DCI. To allow for backwards compatibility the legacy P-RNTI can be mapped to any of the configured P-RNTIs within the legacy paging search space.

As discussed above, utilising a PI-DCI may increase the capacity, but requires coherent detection based on time-frequency synchronisation. The UE therefore has to wake up prior to the PI to receive SSB(s) to synchronise. However, after decoding the PI-DCI the P-DCI can be sent quickly because there is no need for additional SSBs between the PI and P-DCI. The gap becomes too long the UE may enter micro or light sleep to maintain synchronisation and reduce power consumption, compared to a deep sleep where synchronisation is typically lost.

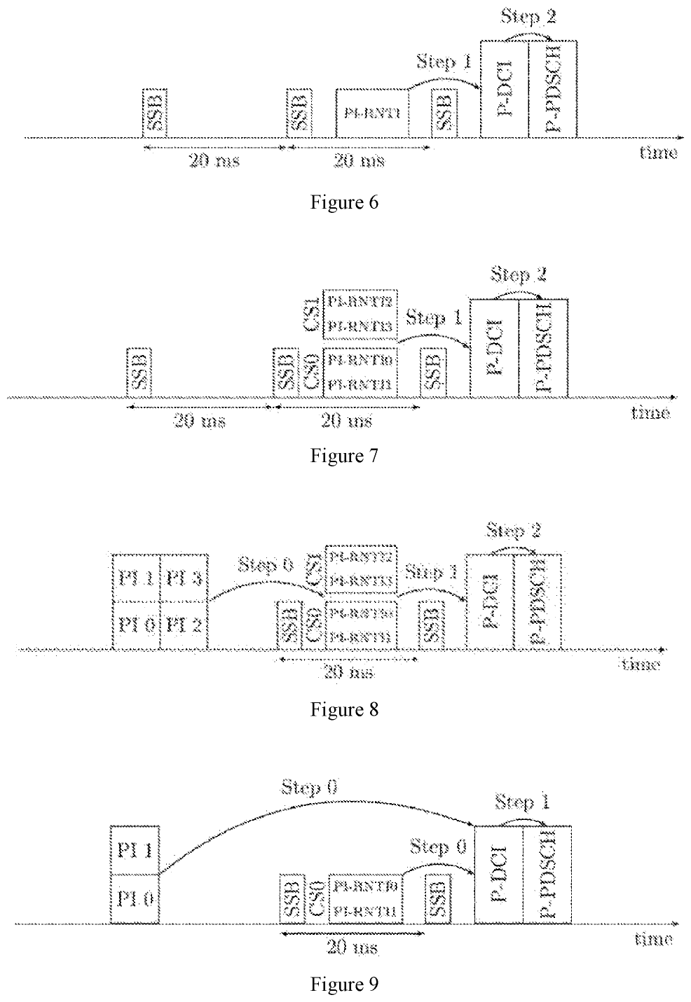

FIG. 6 shows an example in which UEs are configured with one CORESET and one PI-RNTI. All UEs thus attempt to decode the PI-DCI scrambled with PI-RNTI which is transmitted in the configured CORESET. The PI-DCI carries the UE grouping information as described above, for example utilising a bitmap in which each bit corresponds to one or more group. Groups indicated by the PI-DCI (for example those indicated by a 1 in the bitmap) will proceed to decode the P-DCI, with other UEs not expecting a paging message and hence can return to sleep.

The payload size of the PI-DCI may be insufficient for a 1:1 mapping between bits and groups (for example the payload may be 16 bits and 32 groups may be configured), each bit may represent more than one group as discussed above.

The relevant field of the P-DCI is then utilised to refine the grouping information as has been discussed above. The bit configuration for refining groups is known and calculated depending on how many groups are indicated to decode P-DCI in the PI-DCI. For example, if PI-DCI has two groups associated with each bit, four is will indicate 8 groups to receive P-DCI. Eight bits may then be utilised in P-DCI to indicate which of the 8 groups should decode P-PDSCH.

DCI-based PIs can be made group-specific by mapping each group to a combination of CORESET and PI-RNTI (more than one group may map to each combination). Each PI-DCI therefore relates to a smaller number of groups and the granularity indicated to receive P-DCI is improved. FIG. 7 shows an example in which a total of four PI-DCIs are provided using two CORESETs and two PI-RNTIs. The methods discussed above are utilised to indicate the UE groups which should decode P-DCI in each PI-DCI. FIG. 7 shows only one P-DCI, but multiple P-DCIs may also be utilised, each mapped to one or more of the PI-DCIs.

FIG. 8 shows an example in which a combination of RS- and DCI-based PIs are utilised to indicate which UEs should decode the P-DCI. An RS-based PI is transmitted first which is simple for UEs to decode, followed by a DCI-based PI which can provide additional information. This arrangement enables devices such as REDCAP UEs to easily decode the RS-based PI, thus reducing the number of UEs which need to decode a more complex DCI-based PI. The initial RS-based PI also provides signals which can be used by the UE to synchronise in order to receive the PI-DCI and P-DCI, thus reducing the number of SSBs required prior to the PI/P-DCI.

In the example of FIG. 8, resources for four orthogonal RS-based PIs are provided, followed by four DCI-based PIs. Each RS-based PI may map to one DCI-based PI, for example based on the PI-RNTI used to scramble the PI-DCI, but any appropriate mapping may be utilised.

The DCI-based PI may only be transmitted if the common wakeup signal was transmitted in the associated RS-based PI. If a group-specific wakeup signal was transmitted in an RS-based PI the DCI-based PI may not provide further refinement and so may not be necessary. However, if the common wakeup signal is transmitted the DCI-based PI can refine which groups should proceed to decode the P-DCI, using the techniques described hereinbefore.

UEs of different types are likely to be connected to a base station, for example normal UEs (utilising eMBB/URLLC services) and reduced capability (REDCAP) UEs are likely to coexist. The different types of paging process described above may be more appropriate to the different types of device. For example, RS-based PIs may be more appropriate for REDCAP devices due to the reduced power requirements to decode the signals. It may therefore be advantageous to enable a system to configure groups of UEs to use different elements of the paging processes described hereinbefore.

As shown in FIG. 9, a first set of UEs may be configured to detect RS-based PIs (PI 0 and PI 1), while a second set of UEs may be configured to detect DCI-based PIs (PI-RNTI 0 & PI-RNTI 1 transmitted on CORESET 0). The UEs indicated by any of the PIs proceed to receive and decode the P-DCI which may provide further refinement of the groups/UEs that should decode P-PDSCH. Any of the techniques described hereinbefore for multiple PIs or P-DCIs, and means to indicate groups or UEs, may be utilised in conjunction with configuring sets of UEs to receive different PI types.

Various techniques for paging UEs have been disclosed in which one or more PIs are transmitted to indicate which UEs should receive the next PI in a series or a P-DCI. Multiple PIs at each stage of the process may be utilised and mapped to different sets of groups, and multiple P-DCIs may also be provided and mapped to different groups. Multiple RS-based PIs may be transmitted on different resources, and multiple DCI-based PIs may be transmitted on different CORESETs and/or using different PI-RNTIs. Techniques for use of bits within messages to indicate groups or specific UEs have been disclosed, which can be used in appropriate ones of the PIs or P-DCIs as appropriate.

Although not shown in detail any of the devices or apparatus that form part of the network may include at least a processor, a storage unit and a communications interface, wherein the processor unit, storage unit, and communications interface are configured to perform the method of any aspect of the present invention. Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD)® read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor comprising the computer system to cause the processor to perform specified operations. Such instructions, generally referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organisation.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices.

Thus, the elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims Additionally, although a feature may appear to be described in connection with particular embodiments, one skilled in the art would recognise that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Although the present invention has been described in connection with some embodiments, it is not intended to be limited to the specific form set forth herein. Rather, the scope of the present invention is limited only by the accompanying claims Additionally, although a feature may appear to be described in connection with particular embodiments, one skilled in the art would recognise that various features of the described embodiments may be combined in accordance with the invention. In the claims, the term ‘comprising’ or ‘including’ does not exclude the presence of other elements.

1. A method of paging UEs in a cellular communications system, the method performed at a base station, and comprising the steps of
transmitting a first paging indication, wherein the first paging indication includes an indication of UEs which should decode a second paging indication;
transmitting the second paging indication, wherein the second paging indication includes an indication of which of the UEs can expect a paging message in a subsequent paging occasion; and
transmitting a paging message in the subsequent paging occasion for reception by the UEs indicated in the second paging indication.

2. A method of paging UEs in a cellular communications network, the method performed at a UE and comprising the steps of
receiving a first paging indication;
determining whether the first paging indication includes an indication that the UE should decode a second paging indication and if so indicated receiving the second paging indication; and
determining whether the second paging indication includes an indication that the UE should decode a paging message, and if so indicated receiving and decoding the paging message.

3. The method of claim 2, wherein the second paging indication is transmitted subsequent to the first paging indication.

4. The method of claim 2, further comprising transmitting at least one synchronization signal block between the first paging indication and the paging message.

5. The method of claim 2, wherein the first paging indication is reference-signal based.

6. The method of claim 2, wherein the first paging indication is a DCI message.

7. The method of claim 2, wherein the second paging indication is reference signal based.

8. The method of claim 2, wherein the second paging indication is a DCI message.

9. The method of claim 2, wherein the first paging indication indicates a group of UEs, or all UEs, associated with a paging occasion.

10. The method of claim 5, wherein the first paging indication includes at least one sequence corresponding to a pre-defined group of UEs.

11. The method of claim 7, wherein the second paging indication includes at least one sequence corresponding to a pre-defined group of UEs.

12. The method of claim 6, wherein the DCI message of the first paging indication identifies at least one group of UEs.

13. The method of claim 12, wherein the DCI message of the first paging indication includes a bitmap, wherein each bit of the bitmap corresponds to a predefined group of UEs.

14. The method of claim 2, wherein the paging message is a paging DCI message.

15. The method of claim 14, wherein the paging DCI message is a common DCI message.

16. The method of claim 14, wherein the paging DCI message is a group-common DCI message.

17. The method of claim 14, wherein the paging DCI message is scrambled by the relevant P-RNTI.

18. The method of claim 2, wherein the paging message comprises a plurality of paging DCI messages, each associated with a different CORESET and/or scrambled by a different P-RNTI.

19. (canceled)

20. A method of paging indication to UEs in radio resource control (RRC) idle/inactive state, the method performed at a base station and comprising the steps of:
transmitting a downlink control information (DCI) message to the UEs scrambled with a paging indication RNTI, wherein the DCI message includes a paging indication field, wherein each bit in the paging indication field indicates at least one group of UEs to decode a subsequent paging DCI message.

21. A method of paging indication to UEs in radio resource control (RRC) idle/inactive state, the method performed at a UE and comprising the steps of:
receiving a downlink control information (DCI) message scrambled with a paging indication RNTI, wherein the DCI message includes a paging indication field, wherein each bit in the paging indication field indicates at least one group of UEs to decode a subsequent paging DCI message.

22. (canceled)

23. (canceled)
